(19) United States
(12) Patent Application Publication
(10) Pub. No.: US 2026/0230745 A1
(43) Pub. Date: Aug. 6, 2026

(54) ACOUSTIC SIGNAL OUTPUT DEVICE

(71) Applicants: NIPPON TELEGRAPH AND TELEPHONE CORPORATION, Tokyo (JP); NTT sonority, Inc., Tokyo (JP)

(72) Inventors: Hironobu CHIBA, Musashino-shi, Tokyo (JP); Tatsuya KAKO, Musashino-shi, Tokyo (JP); Ryushin KAMETANI, Shinjuku-ku, Tokyo (JP); Jun IWASE, Shinjuku-ku, Tokyo (JP)

(73) Assignees: NIPPON TELEGRAPH AND TELEPHONE CORPORATION, Tokyo (JP); NTT sonority, Inc., Tokyo (JP)

(21) Appl. No.: 19/147,110

(22) PCT Filed: Jan. 11, 2024
(86) PCT No.: PCT/JP2024/000428

§ 371 Date: Jul. 10, 2025

(30) Foreign Application Priority Data
Jan. 13, 2023 (JP) 2023-003511

(51) Int. Cl. H04R 1/32; H04R 3/12

(52) U.S. Cl. CPC H04R 1/323; H04R 3/12; H04R 2201/401; H04R 2460/01

(57) ABSTRACT

An acoustic signal output device is provided, which comprises a driver unit that emits an acoustic signal AC1 in a direction D1 and a driver unit that emits an acoustic signal AC2 in the direction D1. The driver unit and the driver unit are arranged along the same virtual plane, and the driver unit is arranged annularly around the driver unit. In a case where the acoustic signal ACI is emitted from the driver unit and the acoustic signal AC2 is emitted from the driver unit, an attenuation rate of the first acoustic signal at a second point relative to a predetermined first point where the acoustic signal AC1 reaches, the second point being farther from the acoustic signal output device than the first point, is designed to be equal to or less than a predetermined value smaller than an attenuation rate of an acoustic signal at the second point relative to the first point due to air propagation. Alternatively, an attenuation amount of the first acoustic signal at the second point relative to the first point is designed to be equal to or greater than a predetermined value greater than an attenuation amount of the acoustic signal at the second point relative to the first point due to air propagation.

### TECHNICAL FIELD

The present invention relates to an acoustic signal output device, and more particularly to an acoustic signal output device that does not block an external auditory canal.

### BACKGROUND ART

In recent years, increased burden on ears due to wearing of earphones or headphones has become a problem. Devices that reduce the burden on the ears include open-ear type (open-type) earphones and headphones that do not block the external auditory canal.

### PRIOR ART LITERATURE

### Non-Patent Literature

Non-patent literature 1: “WHAT ARE OPEN-EAR HEADPHONES!”, [online], Bose Corporation, [searched on Nov. 21, 2022], Internet <https://www.bose.com/en_us/better_with_bose/open-ear-headphones.html>

### SUMMARY OF THE INVENTION

### Problems to be Solved by the Invention

However, open-ear type earphones and headphones have a problem of significant sound leakage to the surroundings. Such a problem is not limited to open-ear type earphones and headphones and is a problem common to acoustic signal output devices that do not block the external auditory canal, including installed speakers and embedded speakers.

The present invention has been made in view of such points and is directed to providing an acoustic signal output device that does not block the external auditory canal and can suppress sound leakage to the surroundings.

### Means to Solve the Problems

An acoustic signal output device is provided that comprises one or more first driver units that emit a first acoustic signal in a first direction, and one or more second driver units that emit a second acoustic signal in the first direction. Here, the first driver unit and the second driver unit are arranged along the same virtual plane, and the second driver unit is arranged annularly around the first driver unit. In a case where the first acoustic signal is emitted from the first driver unit and the second acoustic signal is emitted from the second driver unit, an attenuation rate of the first acoustic signal at a second point relative to a predetermined first point where the first acoustic signal reaches, the second point being farther from the acoustic signal output device than the first point, is designed to be equal to or less than a predetermined value smaller than an attenuation rate of an acoustic signal at the second point relative to the first point due to air propagation.

Alternatively, an attenuation amount of the first acoustic signal at the second point relative to the first point is designed to be equal to or greater than a predetermined value greater than an attenuation amount of the acoustic signal at the second point relative to the first point due to air propagation.

### Effects of the Invention

According to this structure, it is possible to suppress sound leakage to the surroundings.

### BRIEF DESCRIPTION OF THE DRAWINGS

FIG. 1 is a transparent perspective view illustrating a configuration of an acoustic signal output device of a first embodiment;

FIG. 2A is a transparent perspective plan view illustrating the configuration of the acoustic signal output device of the first embodiment;

FIG. 2B is a transparent perspective front view illustrating the configuration of the acoustic signal output device of the first embodiment;

FIG. 3 is a diagram for explaining supply of electrical signals to the acoustic signal output device of the first embodiment;

FIG. 4A is a diagram for illustrating a usage state of the acoustic signal output device of the first embodiment; FIG. 4B is a diagram for illustrating a state of an acoustic signal emitted from the acoustic signal output device of the first embodiment;

FIG. 5A is a diagram for illustrating a numerical analysis model in a case where a plurality of acoustic emission surfaces that emits acoustic signals is not on the same plane; FIG. 5B is an enlarged view of a region R1 in FIG. 5A;

FIG. 6 is a diagram illustrating a numerical analysis model of acoustic radiation in a case where the plurality of acoustic emission surfaces that emits acoustic signals is not on the same plane;

FIG. 7A is a diagram for illustrating a numerical analysis model in a case where the plurality of acoustic emission surfaces that emits acoustic signals is on the same plane, and other acoustic emission surfaces are arranged coaxially and annularly around one of the acoustic emission surfaces; FIG. 7B is an enlarged view of the region R2 in FIG. 7A;

FIG. 8 is a diagram for illustrating a numerical analysis model of acoustic radiation in a case where the plurality of acoustic emission surfaces that emits acoustic signals is on the same plane, and other acoustic emission surfaces are arranged coaxially and annularly around one of the acoustic emission surfaces;

FIG. 9A is a diagram for illustrating a numerical analysis model in a case where the plurality of acoustic emission surfaces that emits acoustic signals is not on the same plane; FIG. 9B is a diagram for illustrating a numerical analysis model in a case where the plurality of acoustic emission surfaces that emits acoustic signals is on the same plane, and other acoustic emission surfaces are arranged coaxially and annularly around one of the acoustic emission surfaces;

FIG. 10A is a graph for illustrating acoustic characteristics in a case where the plurality of acoustic emission surfaces that emits acoustic signals is not on the same plane; FIG. 10B is a graph for illustrating acoustic characteristics in a case where the plurality of acoustic emission surfaces that emits acoustic signals is on the same plane, and other acoustic emission surfaces are arranged coaxially and annularly around one of the acoustic emission surfaces;

FIG. 11A and FIG. 11B are transparent plan views illustrating a configuration of an acoustic signal output device of a second embodiment; and

FIG. 12 is a transparent plan view illustrating a configuration of an acoustic signal output device of a third embodiment.

### DETAILED DESCRIPTION OF THE EMBODIMENTS

Embodiments of the present invention will be described below with reference to the drawings.

### First Embodiment

First, a first embodiment of the present invention will be described.

### <Configuration>

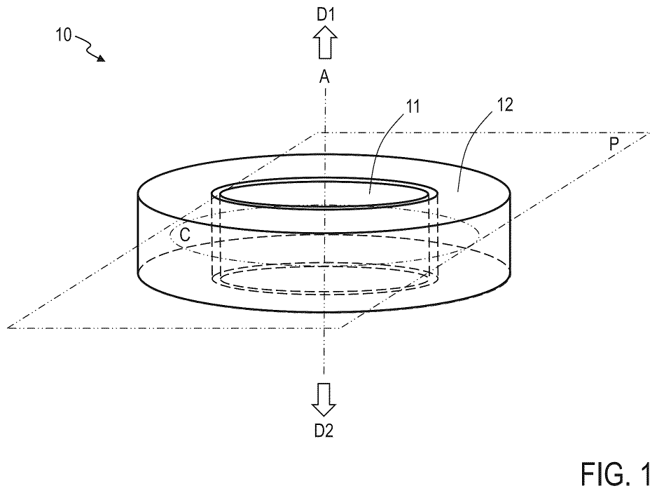

An acoustic signal output device 10 of the present embodiment is a device for acoustic audition (for example, open-ear type (open-type) earphones, headphones, installed speakers, embedded speakers, etc.) that is worn without blocking the user's external auditory canal. As illustrated in FIGS. 1 to 3, the acoustic signal output device 10 of the present embodiment includes a driver unit 11 (first driver unit) that converts an output signal (electrical signal representing an acoustic signal) OUT1 output from a signal processing device 100 into an acoustic signal AC1 (first acoustic signal) and emits this acoustic signal AC1 in a direction D1 (first direction), and a driver unit 12 (second driver unit) that converts an output signal OUT2 output from the signal processing device 100 into an acoustic signal AC2 (second acoustic signal) and emits this acoustic signal AC2 in the direction D1 (first direction). The driver unit 11 and the driver unit 12 are arranged along the same virtual plane P, and the driver unit 12 is arranged annularly around the driver unit 11. Here, in a case where the acoustic signal AC1 is emitted from the driver unit 11 and the acoustic signal AC2 is emitted from the driver unit 12, an attenuation rate of the acoustic signal AC1 at a position P2 (second point) relative to a predetermined position P1 (first point) where the acoustic signal AC1 reaches, the position P2 being farther from the acoustic signal output device 10 than the position P1, is designed to be equal to or less than a predetermined value smaller than an attenuation rate of an acoustic signal at the position P2 relative to the position P1 due to air propagation. Alternatively, an attenuation amount of the acoustic signal AC1 at the position P2 relative to the position P1 is designed to be equal to or greater than a predetermined value greater than an attenuation amount of the acoustic signal at the position P2 relative to the position P1 due to air propagation. Details will be described below.

### <Driver Unit 11>

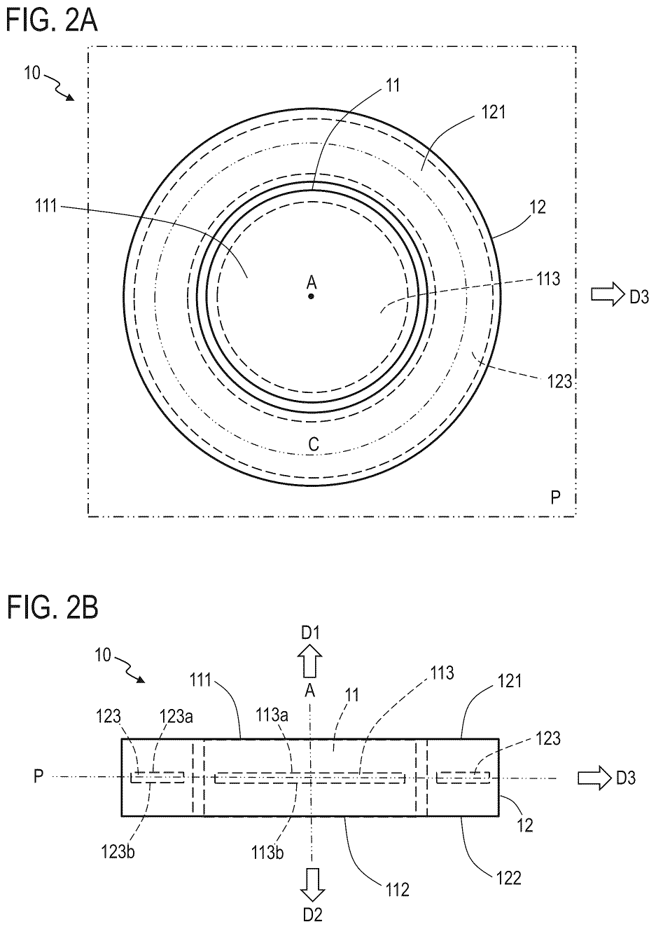

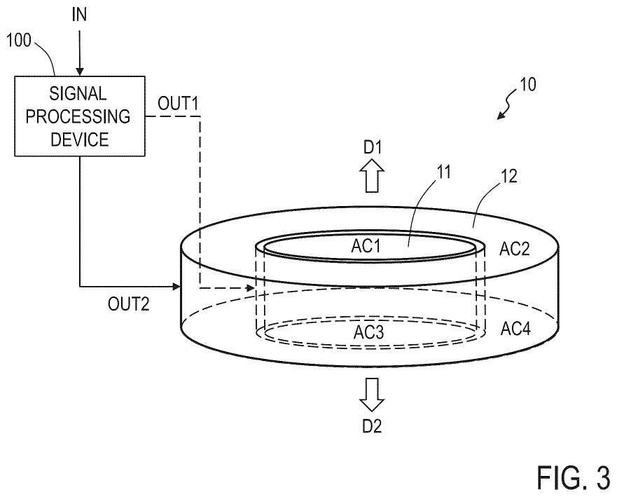

The driver unit (speaker driver unit) 11 is a device (device with a speaker function) that emits (produces sound) the acoustic signal AC1 (first acoustic signal) based on the input output signal OUT1 to one side (in the direction D1) and emits an acoustic signal AC3 (third acoustic signal), which is an antiphase signal (phase inverted signal) of the acoustic signal AC1 or an approximation signal of the antiphase signal, to the other side (in the direction D2). In other words, the acoustic signal emitted from the driver unit 11 to one side (in the direction D1) is referred to as the acoustic signal AC1 (first acoustic signal), and the acoustic signal emitted from the driver unit 11 to the other side (in the direction D2) is referred to as the acoustic signal AC3 (third acoustic signal) (FIG. 3). For example, the driver unit 11 includes a diaphragm 113 that emits the acoustic signal AC1 from one surface 113a in the direction D1 by vibration and emits the acoustic signal AC3 from the other surface 113b in the direction D2 by this vibration (FIG. 2B). In this example, the driver unit 11 emits the acoustic signal AC1 from one side surface 111 in the direction D1 by vibrating the diaphragm 113 based on the input output signal OUT1 and emits the acoustic signal AC3, which is an antiphase signal or an approximation signal of the antiphase signal of the acoustic signal AC1, from the other side surface 112 in the direction D2. In other words, the acoustic signal AC3 is emitted secondarily in association with the emission of the acoustic signal AC1. In addition, the direction D2 (the other side) is, for example, a direction opposite to or substantially opposite to the direction D1 (one side), but the direction D2 does not necessarily have to be strictly the direction opposite to or substantially opposite to the direction D1, and it is only necessary that the direction D2 is different from the direction D1. Depending on a type and shape of the driver unit 11, the acoustic signal AC3 may be exactly the antiphase signal of the acoustic signal AC1, or the acoustic signal AC3 may be an approximation signal of the antiphase signal of the acoustic signal AC1. For example, the approximation signal of the antiphase signal of the acoustic signal AC1 may be (1) a signal obtained by shifting a phase of the antiphase signal of the acoustic signal AC1, (2) a signal obtained by changing (amplifying or attenuating) an amplitude of the antiphase signal of the acoustic signal AC1, or (3) a signal obtained by shifting the phase of the antiphase signal of the acoustic signal AC1 and further changing the amplitude. A phase difference between the antiphase signal of the acoustic signal AC1 and the approximation signal of the antiphase signal is desirably equal to or less than δ₁% of one cycle of the antiphase signal of the acoustic signal AC1. Examples of δ₁% include 1%, 3%, 5%, 10%, and 20%. Furthermore, it is desirable that a difference between the amplitude of the antiphase signal of the acoustic signal AC1 and the amplitude of the approximation signal of the antiphase signal is equal to or less than δ₂% of the amplitude of the antiphase signal of the acoustic signal AC1. Examples of δ₂% include 1%, 3%, 5%, 10%, and 20%. Note that examples of a type of the driver unit 11 can include a dynamic type, a balanced armature type, a hybrid type of the dynamic type and the balanced armature type, and an electrostatic type. Furthermore, the shapes of the driver unit 11 and the diaphragm 113 are not limited. In the present embodiment, for the sake of simplification, an example will be described where the driver unit 11 has a substantially cylindrical outer shape having both end surfaces, and the diaphragm 113 has a substantially disc shape, but this does not limit the present invention. For example, the outer shape of the driver unit 11 may be a rectangular parallelepiped shape, and the diaphragm 113 may have a dome shape. Further, examples of the acoustic signal include sound such as music, speech, sound effects, and ambient sound.

### <Driver Unit 12>

The driver unit (speaker driver unit) 12 is a device (device with a speaker function) that is arranged annularly around the driver unit 11, emits (produces sound) the acoustic signal AC2 (second acoustic signal) based on the input output signal OUT2 to one side (in the direction D1) and emits an acoustic signal AC4 (fourth acoustic signal), which is an antiphase signal (phase inverted signal) or an approximation signal of the antiphase signal of the acoustic signal AC2, to the other side (in the direction D2). In other words, the acoustic signal emitted from the driver unit 12 to one side (in the direction D1) is referred to as the acoustic signal AC2 (second acoustic signal), and the acoustic signal emitted from the driver unit 12 to the other side (in the direction D2) is referred to as the acoustic signal AC4 (fourth acoustic signal) (FIG. 3). For example, the driver unit 12 includes a diaphragm 123 that emits the acoustic signal AC2 from one surface 123a in the direction D1 by vibration and emits the acoustic signal AC4 from the other surface 123b in the direction D2 by this vibration (FIG. 2B). In this example, the driver unit 12 emits the acoustic signal AC2 from one side surface 121 in the direction D1 by vibrating the diaphragm 123 based on the input output signal OUT2 and emits the acoustic signal AC4, which is an antiphase signal or an approximation signal of the antiphase signal of the acoustic signal AC2, from the other side surface 122 in the direction D2. In other words, the acoustic signal AC4 is emitted secondarily in association with the emission of the acoustic signal AC2. Depending on a type and shape of the driver unit 12, the acoustic signal AC4 may be exactly the antiphase signal of the acoustic signal AC2, or the acoustic signal AC4 may be the approximation signal of the antiphase signal of the acoustic signal AC2. For example, the approximation signal of the antiphase signal of the acoustic signal AC2 may be (1) a signal obtained by shifting a phase of the antiphase signal of the acoustic signal AC2, (2) a signal obtained by changing (amplifying or attenuating) an amplitude of the antiphase signal of the acoustic signal AC2, or (3) a signal obtained by shifting the phase of the antiphase signal of the acoustic signal AC2 and further changing the amplitude. A phase difference between the antiphase signal of the acoustic signal AC2 and the approximation signal of the antiphase signal is desirably equal to or less than δ₁% of one cycle of the antiphase signal of the acoustic signal AC2. Examples of δ₁% include 1%, 3%, 5%, 10%, and 20%. Furthermore, it is desirable that a difference between the amplitude of the antiphase signal of the acoustic signal AC2 and the amplitude of the approximation signal of the antiphase signal is equal to or less than δ₂% of the amplitude of the antiphase signal of the acoustic signal AC2. Examples of δ₂% include 1%, 3%, 5%, 10%, and 20%. Note that examples of a type of the driver unit 12 can include a dynamic type, a balanced armature type, a hybrid type of the dynamic type and the balanced armature type, and an electrostatic type.

In the present embodiment, the driver unit 11 (first driver unit) differs from the driver unit 12 (second driver unit) in at least one of shape or size. In the present embodiment, for the sake of simplification, an example will be described where the driver unit 12 (second driver unit) is a ring-shaped (donut-shaped) driver unit that surrounds the driver unit 11 (first driver unit). By this means, uniform and high sound leakage suppression effects can be expected. However, this does not limit the present invention, and the shape of the driver unit 12 may be any form, such as an oval ring type or rectangular frame type, as long as the driver unit 12 can be arranged annularly around the driver unit 11.

In addition, the driver unit 12 (second driver unit) is arranged annularly around the driver unit 11 (first driver unit), and the driver unit 11 and the driver unit 12 are arranged along the same virtual plane P (FIG. 1, FIGS. 2A and 2B). For example, the driver units 11 and 12 are arranged to both pass through the virtual plane P. FIGS. 1, 2A, and 2B illustrate an example where the diaphragm 113 of the driver unit 11 and the diaphragm 123 of the driver unit 12 are arranged to both pass through the virtual plane P. However, this does not limit the present invention, and it is only necessary that the driver unit 11 and the driver unit 12 are arranged along the virtual plane P. For example, the surface 111 of the driver unit 11 and the surface 121 of the driver unit 12 may be arranged to pass through the virtual plane P or its vicinity, or the surface 112 of the driver unit 11 and the surface 122 of the driver unit 12 may be arranged to pass through the virtual plane P or its vicinity. The virtual plane P may be a plane that is orthogonal to the direction D1, or a plane that is substantially orthogonal to the direction D1, or a plane that is orthogonal to the direction D2, or a plane that is approximately orthogonal to the direction D2. Furthermore, the surface 111 of the driver unit 11 and the surface 121 of the driver unit 12 do not have to be arranged on the same plane, and the surface 112 of the driver unit 11 and the surface 122 of the driver unit 12 do not have to be arranged on the same plane either.

Preferably, the driver unit 12 (second driver unit) is arranged along a virtual circle C that is coaxial with a central axis A of the driver unit 11 (first driver unit) (FIGS. 1, 2A). By this means, sound leakage suppression effects over a wide area can be expected. For example, the driver unit 12 may include the virtual circle C, or the driver unit 12 may be positioned in the vicinity of the virtual circle C. For example, the central axis A is orthogonal to or substantially orthogonal to the virtual plane P. By this means, high sound leakage suppression effects can be expected. However, this does not limit the present invention, and the central axis A does not have to be orthogonal or substantially orthogonal to the virtual plane P. Furthermore, the virtual circle C may exist on the virtual plane P, or may exist on a plane that is parallel or substantially parallel to the virtual plane P.

<Phase of Acoustic Signals Emitted from Driver Units 11, 12>

As illustrated in FIG. 3, the signal processing device 100 converts an input signal (electrical signal representing an acoustic signal) IN into an output signal OUT1 and an output signal OUT2. The output signal OUT1 is input to the driver unit 11, and the driver unit 11 emits the acoustic signals AC1, AC3 as described above. The output signal OUT2 is input to the driver unit 12, and the driver unit 12 emits the acoustic signals AC2, AC4 as described above. Here, the signal processing device 100 converts the input signal into the output signal OUT1 and the output signal OUT2 so that an amount of sound leakage from the acoustic signals emitted from the driver units 11, 12 becomes small at a predetermined position. For example, the signal processing device 100 converts the input signal into the output signal OUT1 and the output signal OUT2 so that the amount of sound leakage of the acoustic signals emitted from the driver units 11, 12 is minimized at a predetermined position away from the user's ear. For example, the signal processing device 100 converts the input signal IN so that the output signal OUT2 is an antiphase signal of the output signal OUT1 or an approximation signal of the antiphase signal of the output signal OUT1. In this case, the acoustic signal AC2 emitted from the driver unit 12 becomes the antiphase signal of the acoustic signal AC1 emitted from the driver unit 11 or the approximation signal of the antiphase signal of the acoustic signal AC1.

In a case where the acoustic signal output device 10 is positioned near the user's ear, sound pressure of the acoustic signals can be minimized at a plurality of positions away from the user's ear by controlling a phase relationship between the acoustic signal AC1 and the acoustic signal AC2. For example, in a case where the acoustic signal AC2 emitted from the driver unit 12 is the antiphase signal or the approximation signal of the antiphase signal of the acoustic signal AC1 emitted from the driver unit 11, the acoustic signal AC1 and the acoustic signal AC2 cancel out each other at a distance from the acoustic signal output device 10, which makes it possible to minimize sound pressure of the acoustic signals at a plurality of positions away from the user's ears. On the other hand, the driver unit 11 differs from the driver unit 12 in at least one of shape or size. Due to differences in the shape and the size, the acoustic signal AC1 and the acoustic signal AC2 do not completely cancel out each other in the vicinity of the acoustic signal output device 10, which makes it possible to ensure a constant sound pressure near the user's ears. This results in making it possible to ensure the necessary sound pressure near the user's ears while suppressing sound leakage of the acoustic signals at the plurality of positions away from the user's ears.

In other words, the acoustic signal output device 10 is designed so that in a case where the acoustic signal AC1 (first acoustic signal) is emitted from the driver unit 11 (first driver unit) and the acoustic signal AC2 (second acoustic signal) is emitted from the driver unit 12 (second driver unit), an attenuation rate η₁₁ of the acoustic signal AC1 (first acoustic signal) at a position P2 (second point) relative to a position P1 (first point) can be made equal to or less than a predetermined value ηₜₕ, or an attenuation amount η₁₂ of the acoustic signal AC1 (first acoustic signal) at the position P2 (second point) relative to the position P1 (first point) can be made equal to or greater than a predetermined value ωₜₕ. This makes it possible to suppress sound leakage while ensuring sound pressure in the vicinity of the acoustic signal output device 10.

The position P1 (first point) is a predetermined point where the acoustic signal AC1 (first acoustic signal) emitted from the driver unit 11 reaches. The position P2 (second point) is a predetermined point that is farther from the acoustic signal output device 10 than the position P1 (first point). The predetermined value ηₜₕ is a value (low value) that is smaller than an attenuation rate η₂₁ of an arbitrary or specific acoustic signal (sound) at the position P2 (second point) relative to the position P1 (first point) due to air propagation. The predetermined value ωₜₕ is greater than an attenuation amount η₂₂ of an arbitrary or specific acoustic signal (sound) at the position P2 (second point) relative to the position P1 (first point) due to air propagation. In other words, the acoustic signal output device 10 of the present embodiment is designed so that the attenuation rate η₁₁ is equal to or less than the predetermined value ηₜₕ, which is smaller than the attenuation rate η₂₁, or the attenuation amount η₁₂ is equal to or greater than the predetermined value ωₜₕ, which is greater than the attenuation amount η₂₂. The acoustic signal AC1 propagates through the air from the position P1 to the position P2 and is attenuated due to this air propagation and the acoustic signal AC2. The attenuation rate η₁₁ is a ratio (AMP₂(AC1)/AMP₁(AC1)) of a magnitude AMP₂(AC1) of the acoustic signal AC1 at the position P2, which has been attenuated due to air propagation and the acoustic signal AC2, to a magnitude AMP₁(AC1) of the acoustic signal AC1 at the position P1. Furthermore, the attenuation amount η₁₂ is a difference (|AMP₁(AC1)−AMP₂(AC₁)|) between the magnitude AMP₁(AC1) and the magnitude AMP₂(AC1). On the other hand, in a case where the acoustic signal AC2 is not assumed, an arbitrary or specific acoustic signal ACₐᵣ that propagates through the air from the position P1 to the position P2 is attenuated due to air propagation, not due to the acoustic signal AC2. The attenuation rate η₁₂ is a ratio (AMP₂(ACₐᵣ)/AMP₁(ACₐᵣ)) of a magnitude AMP₂(ACₐᵣ) of the acoustic signal ACₐᵣ at the position P2, which has been attenuated due to air propagation (not due to the acoustic signal AC2), to a magnitude AMP₁(ACₐᵣ) of the acoustic signal ACₐᵣ at the position P1. Furthermore, the attenuation amount η₂₂ is a difference (|AMP₁(ACₐᵣ)−AMP₂(ACₐᵣ)|) between the magnitude AMP₁(ACₐᵣ) and the magnitude AMP₂(ACₐᵣ). For example, a magnitude of an acoustic signal is sound pressure of the acoustic signal or energy of the acoustic signal. The term “sound leakage components” refer to components of the acoustic signal AC1 emitted from the driver unit 11 that are likely to arrive in areas outside of the user who wears the acoustic signal output device 10 (for example, to people other than the user who wears the acoustic signal output device 10), for example. For example, the “sound leakage components” refer to components of the acoustic signal AC1 that propagate in directions other than the direction D1, or components that propagate in the direction D1 and reach positions other than the position of the user.

In the present embodiment, the acoustic signals AC3, AC4 are also emitted from the driver units 11, 12 in the direction D2 (FIG. 3). By controlling the acoustic signals AC1, AC2, AC3, AC4 to minimize the sound pressure of the acoustic signals at a plurality of positions away from the user's ears, it is possible to minimize the sound pressure of the acoustic signals at the plurality of positions away from the user's ears. For example, in a case where the acoustic signal AC2 emitted from the driver unit 12 is the antiphase signal or the approximation signal of the antiphase signal of the acoustic signal AC1 emitted from the driver unit 11, and the acoustic signal AC4 emitted from the driver unit 12 is the antiphase signal or the approximation signal of the antiphase signal of the acoustic signal AC3 emitted from the driver unit 11, at a distance from the acoustic signal output device 10, the acoustic signal AC1 and the acoustic signal AC2 cancel out each other, the acoustic signal AC3 and the acoustic signal AC4 cancel out each other, the acoustic signal AC1 and the acoustic signal AC3 cancel out each other, and the acoustic signal AC2 and the acoustic signal AC4 cancel out each other, which makes it possible to minimize the sound pressure of the acoustic signals at the plurality of positions away from the user's ears. On the other hand, the driver unit 11 differs from the driver unit 12 in at least one of shape or size, and thus, in the vicinity of the acoustic signal output device 10, it is possible to ensure a constant sound pressure near the user's ears without the acoustic signals being completely canceled out each other. This results in making it possible to ensure the necessary sound pressure near the user's ears while suppressing sound leakage of the acoustic signals at the plurality of positions away from the user's ears.

In other words, the acoustic signal output device 10 is designed so that in a case where the acoustic signals AC1, AC3 (first acoustic signal and third acoustic signal) are emitted from the driver unit 11 (first driver unit), and the acoustic signals AC2, AC4 (second acoustic signal and fourth acoustic signal) are emitted from the driver unit 12 (second driver unit), the attenuation rate η₁₁ of at least one of the acoustic signals AC1, AC2, AC3, AC4 (from the first acoustic signal to the fourth acoustic signal) at the position P2 (second point) relative to the position P1 (first point) can be made equal to or less than the predetermined value ηₜₕ, or the attenuation amount η₁₂ of at least one of the acoustic signals AC1, AC2, AC3, AC4 (from the first acoustic signal to the fourth acoustic signal) at the position P2 relative to the position P1 can be made equal to or greater than the predetermined value ωₜₕ. For example, the acoustic signal output device 10 emits acoustic signals AC1, AC3 from the driver unit 11, and acoustic signals AC2, AC4 from the driver unit 12, so that the attenuation rates n11 of the acoustic signals AC1, AC2, AC3, AC4 at position P2 relative to position P1 can be made equal to or less than a predetermined value nth, or the attenuation amounts η₁₂ of the acoustic signals AC1, AC2, AC3, AC4 at position P2 relative to position P1 can be made equal to or greater than a predetermined value ωₜₕ. Here, the acoustic signal ACX (AC1, AC2, AC3, AC4, that is, X=1,2, 3, 4) propagates through the air from the position P1 to the position P2 and is attenuated due to this air propagation and the acoustic signal ACY (Y=1, 2, 3, 4 and Y≠X). The attenuation rate η₁₁ is a ratio (AMP₂(ACX)/AMP₁(ACX)) of a magnitude AMP₂(ACX) of the acoustic signal ACX at the position P2, which has been attenuated due to air propagation and the acoustic signal ACY, to a magnitude AMP₁(ACX) of the acoustic signal ACX at the position P1. Furthermore, the attenuation amount η₁₂ is a difference (|AMP₁(ACX)−AMP₂(ACX)|) between the magnitude AMP₁(ACX) and the magnitude AMP₂(ACX). On the other hand, in a case where the acoustic signal ACY is not assumed, an arbitrary or specific acoustic signal ACₐᵣ that propagates through the air from the position P1 to the position P2 is attenuated due to air propagation, not due to the acoustic signal ACY. The attenuation rate η₂₁ is a ratio (AMP₂(ACₐᵣ)/AMP₁(ACₐᵣ)) of a magnitude AMP₂(ACₐᵣ) of the acoustic signal ACₐᵣ at the position P2, which has been attenuated due to air propagation (not due to the acoustic signal ACY), to a magnitude AMP₁(ACₐᵣ) of the acoustic signal ACₐᵣ at the position P1. Furthermore, the attenuation amount η₂₂ is a difference (|AMP₁(ACₐᵣ)−AMP₂(ACₐᵣ)|) between the magnitude AMP₁(ACₐᵣ) and the magnitude AMP₂(ACₐᵣ). This makes it possible to further suppress sound leakage.

### <Usage States>

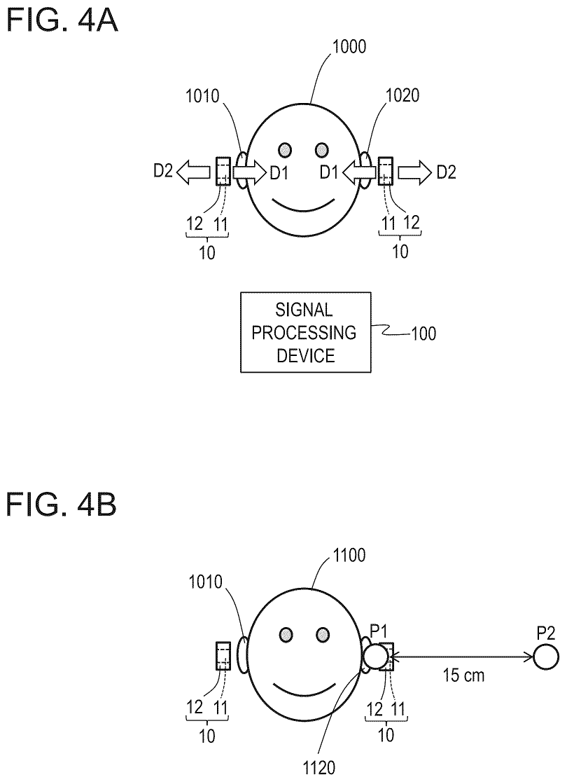

FIGS. 4A and 4B illustrate usage states of the acoustic signal output device 10. In the example of FIG. 4A, the acoustic signal output device 10 is attached to each of a right ear 1010 and a left ear 1020 of a user 1000. An arbitrary mounting mechanism can be used for attachment of the acoustic signal output device 10 to the ear. The acoustic signal output devices 10 are positioned near the right ear 1010 and the left ear 1020 of the user 1000 while the direction D1 is oriented to the user 1000 side. The driver unit 11 emits the acoustic signal AC1 in the direction D1 and emits the acoustic signal AC3 in the direction D2. The driver unit 12 emits the acoustic signal AC2 in the direction D1 and emits the acoustic signal AC4 in the direction D2.

As described above, at the positions of the right ear 1010 and the left ear 1020 located near the driver units 11, 12, the sound pressure of the acoustic signals AC1, AC2 emitted from the driver units 11, 12 in the direction D1 is ensured. On the other hand, sound leakage of the acoustic signals can be suppressed at a plurality of positions away from the right ear 1010 and the left ear 1020. In other words, the attenuation rate ni of at least one of the acoustic signals AC1, AC2, AC3, AC4 at the position P2 relative to the position P1 can be made equal to or less than the predetermined value ηₜₕ, or the attenuation amount η₁₂ of at least one of the acoustic signals AC1, AC2, AC3, AC4 at the position P2 relative to the position P1 can be made equal to or greater than the predetermined value ωₜₕ. In addition, FIG. 4B illustrates an example where the position P2 is located 15 cm outward away from the position P1, but this does not limit the present invention.

### <Numerical Analysis Example>

A numerical analysis example demonstrating sound leakage suppression effects of the acoustic signal output device 10 of the present embodiment will be indicated.

One of the features of the acoustic signal output device 10 of the present embodiment is that the driver unit 12 is arranged annularly around the driver unit 11, and that the driver unit 11 and the driver unit 12 are arranged along the same virtual plane P. Furthermore, it is preferable that the driver unit 12 is arranged along the virtual circle C that is coaxial with the central axis A of the driver unit 11. Here, the sound leakage suppression effects will be compared between a case where these features are provided and a case where these features are not provided through numerical analysis.

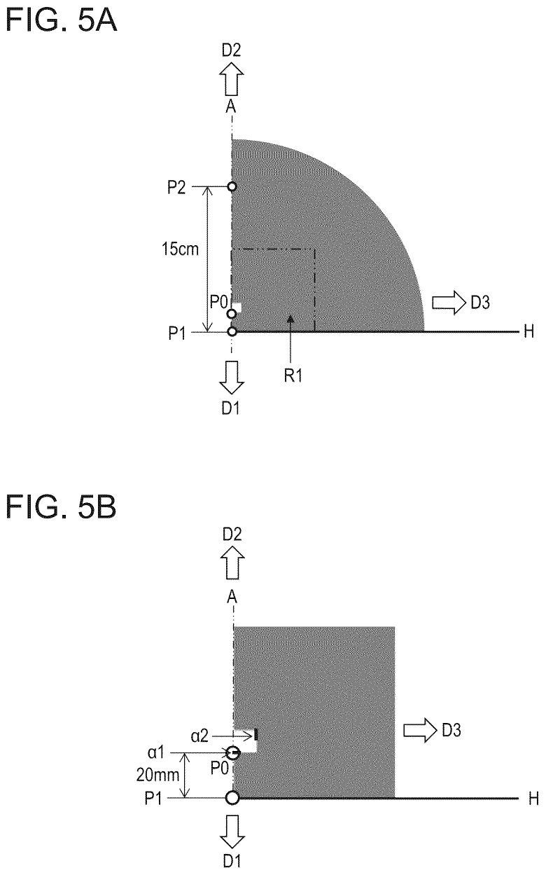

FIG. 5A illustrates a numerical analysis model in a case where the features of the present embodiment described above are not provided, and FIG. 5B illustrates an enlarged view of a region R1 in FIG. 5A. A horizontal axis H in FIGS. 5A and 5B represents a perfectly reflective surface modeling the user's head surface, while a vertical axis represents an axis modeling the central axis A of the acoustic signal output device. A space of this numerical analysis model is rotationally symmetric around the central axis A. In the space of this example, positions P0, P1, P2 are arranged on the central axis A. P0 corresponds to an installation reference position of the acoustic signal output device 10 (for example, P0 is a point on the surface of the acoustic signal output device 10), the position P1 corresponds to a position of the user's ear, and P2 corresponds to a position away from the position P1 outward from the acoustic signal output device 10. α1 represents an acoustic emission surface that emits acoustic signals in the direction D1 (direction of the perfectly reflective surface, toward the position P1) centered around the central axis A and along the central axis A. α2 represents an acoustic emission surface that emits acoustic signals in the direction D3, which is parallel to the horizontal axis H that is orthogonal to the central axis A. A distance between the position P1 and the acoustic emission surface α1 , is 20 mm, and a distance between the position P1 and the position P2 is 15 cm.

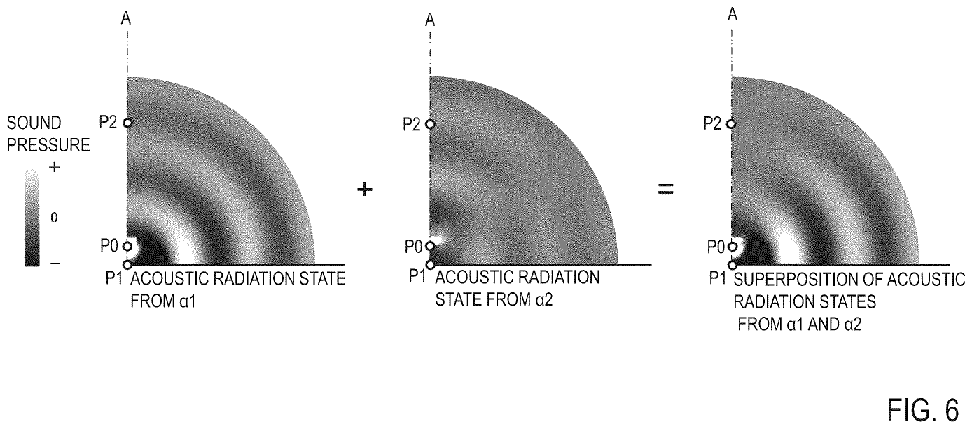

FIG. 6 indicates the numerical analysis results in a case where the features of the present embodiment described above are not provided. FIG. 6 indicates an acoustic radiation state from the acoustic emission surface α1, an acoustic radiation state from the acoustic emission surface α2, and a superposition (mix) of the acoustic radiation states from the acoustic emission surfaces α1, α2. Here, control is performed to suppress sound leakage at the position P2. FIG. 6 also indicates the acoustic radiation states of the acoustic signals at 5120 Hz. The sound pressures is higher at a position where color is closer to white or black (the sound pressure of a positive acoustic signal is higher at a position where the color is closer to white, and the sound pressure of a negative acoustic signal is higher at a position where the color is closer to black), and the sound pressure is lower at a position where the color is closer to neutral color (gray) between white and black. In a low frequency (long wavelength) band, sound leakage can be suppressed to some extent also with this configuration. However, in a high frequency (short wavelength) band, spatial distribution of waves emitted by each of the acoustic emission surface α1 and the acoustic emission surface α2 differs, and thus, it is difficult to suppress sound leakage over a wide spatial range. For example, as illustrated in FIG. 6, there can be seen many regions where the color is close to white or black in a direction deviating from the central axis A in the superposition of the acoustic radiation states from the acoustic emission surfaces α1, α2 at 5120 Hz, which indicates that sound leakage occurs in these regions.

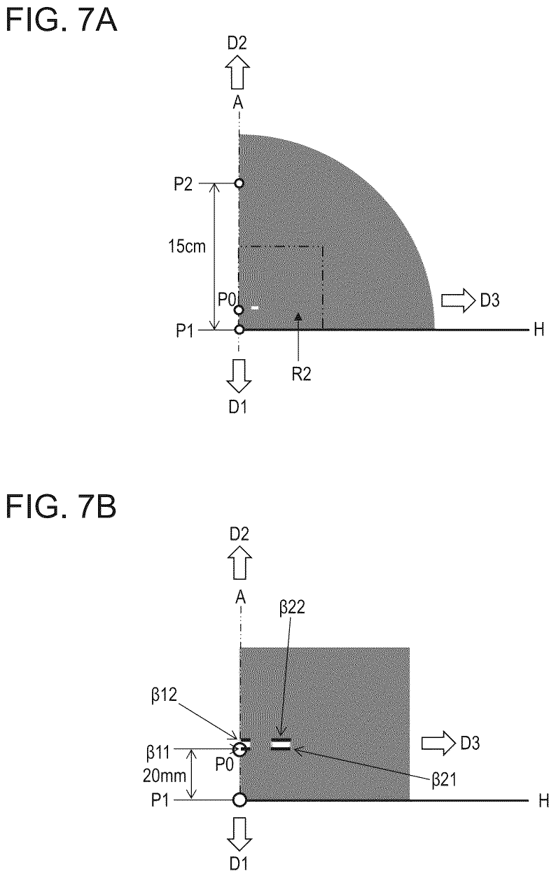

FIG. 7A illustrates a numerical analysis model in a case where the features of the present embodiment described above are provided, and FIG. 7B illustrates an enlarged view of a region R2 in FIG. 7A. The horizontal axis H in FIGS. 7A and 7B represents a perfectly reflective surface modeling the user's head surface, while the vertical axis represents an axis modeling the central axis A of the acoustic signal output device. A space of this numerical analysis model is rotationally symmetric around the central axis A. Also in the space of this example, the positions P0, P1, P2 are arranged on the central axis A. P0 corresponds to the installation reference position of the acoustic signal output device 10, the position P1 corresponds to the position of the user's ear, and P2 corresponds to a position away from the position P1 outward from the acoustic signal output device 10. β11 represents an acoustic emission surface (corresponding to the surface 111 of the driver unit 11) that emits an acoustic signal (corresponding to the acoustic signal AC1) in the direction D1 (direction of the perfectly reflective surface, toward the position P1) centered around the central axis A. β12 represents an acoustic emission surface (corresponding to the surface 112 of the driver unit 11) that emits an acoustic signal (corresponding to the acoustic signal AC3) in the direction D2 (direction opposite to the direction D1) centered around the central axis A. β21 represents an acoustic emission surface (corresponding to the surface 121 of the driver unit 12) that emits an acoustic signal (corresponding to the acoustic signal AC2) in the direction D1 (direction of the perfectly reflective surface, toward the position P1). β22 represents an acoustic emission surface (corresponding to the surface 122 of the driver unit 12) that emits an acoustic signal (corresponding to the acoustic signal AC4) in the direction D2 (direction opposite to the direction D1). Here, the acoustic emission surfaces β11, β12, β21, β22 are arranged along a virtual plane parallel to the horizontal axis H, and the acoustic emission surfaces β21, β22 are arranged annularly around the acoustic emission surfaces β11, β12. In addition, the acoustic emission surfaces β21, β22 are arranged along a virtual circle coaxial with the central axis A of the acoustic emission surfaces β11, β12. A distance between the position P1 and the acoustic emission surface β11 is 20 mm, and a distance between the position P1 and the position P2 is 15 cm.

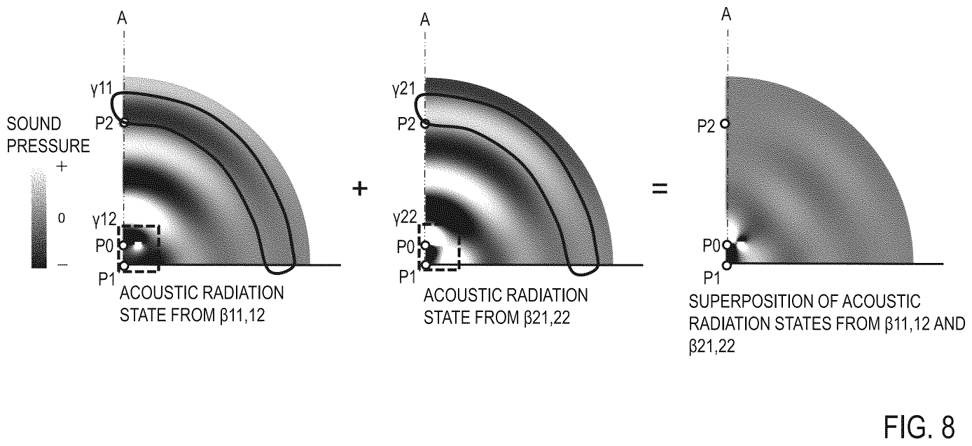

FIG. 8 indicates the numerical analysis results in a case where the features of the present embodiment described above are provided. FIG. 8 indicates an acoustic radiation state from the acoustic emission surfaces β11, β12, an acoustic radiation state from the acoustic emission surfaces β21, β22, and a superposition (mix) of the acoustic radiation states from the acoustic emission surfaces β11, β12, β21, β22. Also here, control is performed to suppress sound leakage at the position P2. FIG. 8 also indicates the acoustic radiation states of the acoustic signals at 5120 Hz. The sound pressure is higher at a position where color is closer to white or black (the sound pressure of a positive acoustic signal is higher at a position where the color is closer to white, and the sound pressure of a negative acoustic signal is higher at a position where the color is closer to black), and the sound pressure is lower at a position where the color is closer to neutral color (gray) between white and black. To suppress sound leakage over a wide range away from the user's ear position, it is necessary that, over the wide range away from the user's ear position, the distribution (1) of the acoustic radiation state from the acoustic emission surfaces β11, β12 is, as much as possible, positively or negatively inverted from the distribution (2) of the acoustic radiation state from the acoustic emission surfaces β21, 22. Due to basic property of an acoustic signal, a wavefront spreads out in a spherical shape. Thus, the above distribution (1) is positively or negatively inverted from the distribution (2) at a distance from P1 in a case where the acoustic emission surfaces β11, β12, β21, β22 are arranged along the same virtual plane, and the acoustic emission surfaces β21, β22 are arranged annularly around the acoustic emission surfaces β11, β12. Furthermore, the acoustic emission surfaces β21, β22 are desirably arranged along a virtual circle coaxial with the central axis A of the acoustic emission surfaces β11, β12. More preferably, it is desirable that centers of spherical wavefronts emitted from the acoustic emission surfaces β11, β12, ββ21, β22 (central positions of movement of the respective diaphragms) coincide or substantially coincide. In a case where such conditions are met, as illustrated in FIG. 8, the distribution (1) of the acoustic radiation state from the acoustic emission surfaces β11, β12 (for example, a region γ11) is positively or negatively inverted from the distribution (2) of the acoustic radiation state from the acoustic emission surfaces β21, β22 (for example, a region γ21) over a wide area away from the user's ears. On the other hand, in the vicinity of the user's ears, the distribution (1) of the acoustic radiation state from the acoustic emission surfaces β11, β12 (for example, a region γ12) is not positively or negatively inverted from the distribution (2) of the acoustic radiation state from the acoustic emission surfaces β21, β22 (for example, a region β22). As a result, in a state of the superposition of the acoustic radiation states from the acoustic emission surfaces β11, β12, β21, β22, the sound pressure is low (the color is close to gray) over a wide area away from the user's ears, and the sound pressure is high (the color is close to black) in the vicinity of the user's ears. In other words, by providing the features of the present embodiment described above, it is possible to ensure a constant sound pressure near the user's ear while suppressing sound leakage over a wide area away from the user's ear.

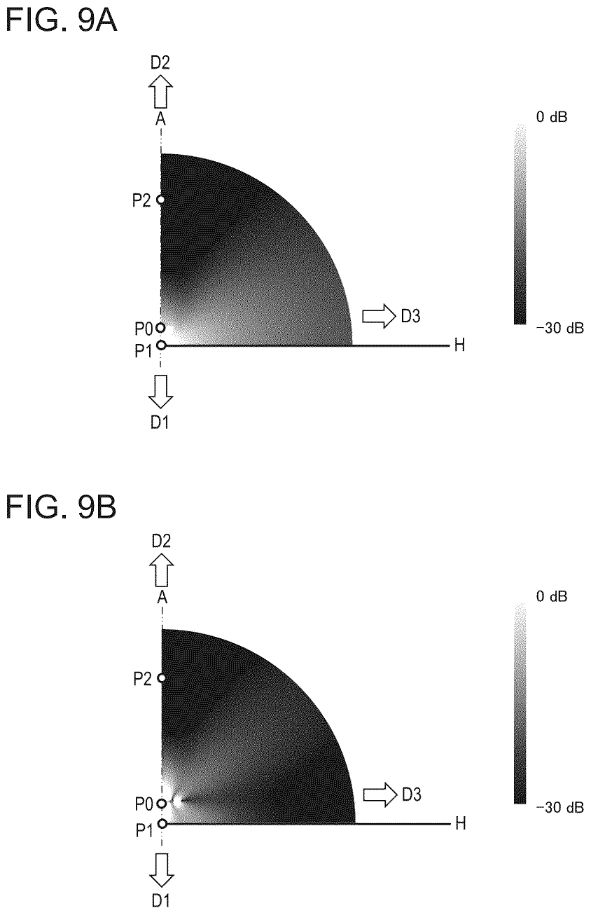

FIG. 9A indicates numerical analysis results in a case where the features of the present embodiment described above are not provided (FIGS. 5A and 5B), and FIG. 9B indicates numerical analysis results in a case where the features of the present embodiment described above are provided (FIGS. 7A and 7B). The conditions are the same as in FIGS. 5A, 5B, 7A, and 7B. However, in FIGS. 9A and 9B, the sound pressure is represented based on the sound pressure at the position P1, which corresponds to the user's ear position. The sound pressure at the position P1 is represented in white, and the sound pressure is lower at a position where the color is closer to black. As illustrated in FIG. 9A, it can be seen that sound leakage occurs in a region away from the user's ears in a case where the features of the present embodiment are not provided. On the other hand, as illustrated in FIG. 9B, in a case where the features of the present embodiment are provided, it can be seen that a constant sound pressure can be ensured near the user's ear while suppressing sound leakage over a wide area away from the user's ear.

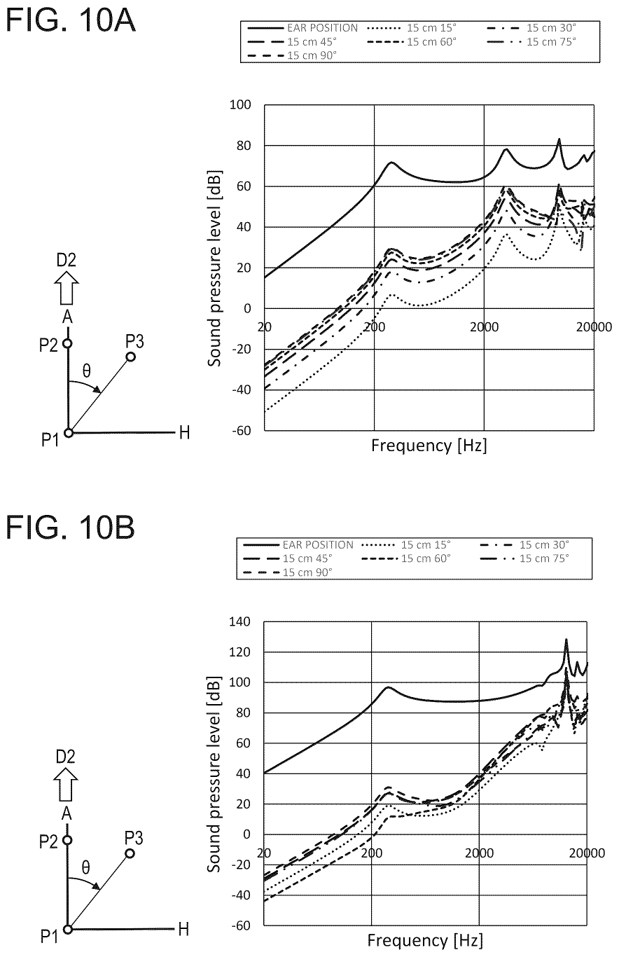

FIG. 10A indicates numerical analysis results in a case where the features of the present embodiment described above are not provided (FIGS. 5A and 5B), and FIG. 10B indicates numerical analysis results in a case where the features of the present embodiment described above are provided (FIGS. 7A and 7B). A vertical axis of FIGS. 10A and 10B represents the sound pressure (sound pressure level [dB]) and the horizontal axis represents a frequency (frequency [Hz]). A value labeled with “ear position” represents sound pressure at the position P1, which corresponds to the ear position, and a value labeled with “15 θ°” represents sound pressure at a position P3 obtained by rotating the position P2 by an angle θ (angle in a clockwise direction) in a rotation direction toward the horizontal axis H that represents the perfectly reflective surface from the central axis A that passes through the position P1 and the position P2 (a distance between the position P1 and the position P2 and a distance between the position P1 and the position P3 are both 15 cm). As can be seen by comparing FIG. 10A and FIG. 10B, even in a case where control is performed to suppress sound leakage at the position P2, in a case where the features of the present embodiment described above are provided (FIG. 10B), it can be seen that, compared to a case where these features are not provided (FIG. 10A), the sound pressure can be ensured near the user's ear while suppressing sound leakage also widely at the position P3 other than the position P2. Note that while an example has been indicated here where the central axis A passes through the position P1 and the position P2, this does not limit the present invention, and at least one of the position P1 or the position P2 does not have to pass through the central axis A.

### <Features of the Present Embodiment>

As described above, in the present embodiment, while the sound pressure is ensured near the user's ear, sound leakage can be suppressed over a wide area away from the user's ear.

### Second Embodiment

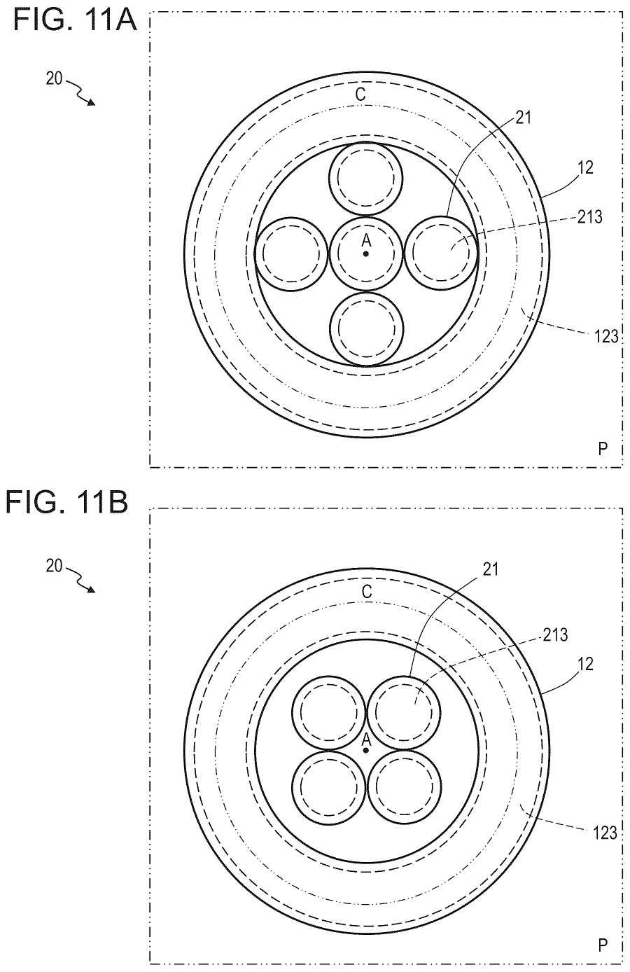

The acoustic signal output device 10 of the first embodiment includes one driver unit 11 (first driver unit) and one driver unit 12 (second driver unit) arranged annularly around the driver unit 11. However, the acoustic signal output device may include a plurality of driver units 11 (first driver units) and one driver unit 12 (second driver unit) arranged annularly around the driver units 11. An acoustic signal output device 20 illustrated in FIG. 11A includes five driver units 21 and one driver unit 12 arranged annularly around the five driver units 21. In this example, one driver unit 21 is positioned on the central axis A, four driver units 21 are arranged around the one driver unit 21, and further, one driver unit 12 is arranged annularly around the four driver units 21. The central axis passes through the center of the five driver units 21. The acoustic signal output device 20 illustrated in FIG. 11B includes four driver units 21 and one driver unit 12 arranged annularly around the four driver units 21. In this example, four driver units 21 are arranged around the central axis A, and one driver unit 12 is arranged annularly around the four driver units 21. The central axis passes through the center of the four driver units 21. In both examples of FIG. 11A and FIG. 11B, the driver unit 21 and the driver unit 12 are arranged along the same virtual plane P. For example, the driver units 21, 12 are arranged to both pass through the virtual plane P. For example, a diaphragm 213 of the driver unit 21 and a diaphragm 123 of the driver unit 12 are arranged to both pass through the virtual plane P. However, this does not limit the present invention, and it is only necessary that the driver unit 21 and the driver unit 12 are arranged along the virtual plane P. For the sake of simplifying the explanation, an example will be described here where the driver unit 21 has a substantially cylindrical outer shape with both end surfaces, and its diaphragm 213 has a substantially disc shape, but this does not limit the present invention. For example, the outer shape of the driver unit 21 may be a rectangular parallelepiped shape, and the diaphragm 213 may have a dome shape. FIGS. 11A and 11B are merely examples, and a plurality of driver units 21 may be arranged at other positions. In addition, the driver unit 21 may differ from the driver unit 12 in at least one of shape or size, or may have the same shape and size. Even if the driver unit 21 and the driver unit 12 have the same shape and size, number of the driver units 21 is different from number of the driver units 12, and thus, the acoustic signals AC1, AC2, AC3, AC4 do not completely cancel out each other in the vicinity of the acoustic signal output device 20, which makes it possible to ensure a constant sound pressure near the user's ears. On the other hand, at a distance from the acoustic signal output device 20, the acoustic signals cancel out each other, so that it is possible to suppress sound leakage of the acoustic signals at a plurality of positions away from the user's ears. Similarly to the first embodiment, preferably, the driver unit 12 (second driver unit) is arranged along the virtual circle C that is coaxial with the central axis A of the plurality of driver units 21 (first driver units). For example, the driver unit 12 may include the virtual circle C, or the driver unit 12 may be positioned in the vicinity of the virtual circle C. By this means, sound leakage suppression effects over a wide area can be expected.

### Third Embodiment

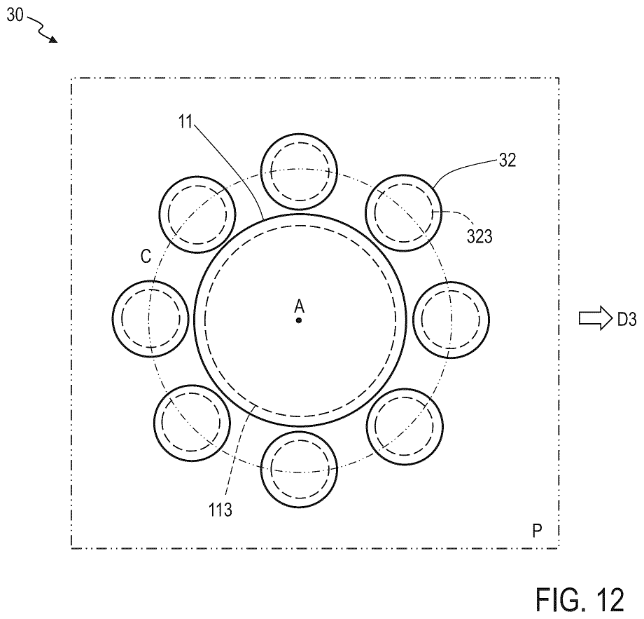

As illustrated in FIG. 12, an acoustic signal output device 30 may include one driver unit 11 and a plurality of driver units 32 arranged annularly around the driver unit 11. The driver unit 11 and the driver units 32 are arranged along the same virtual plane P. For example, the driver units 11, 32 are arranged to both pass through the virtual plane P. For example, the diaphragm 113 of the driver unit 11 and diaphragms 323 of the driver units 32 are arranged to both pass through the virtual plane P. However, this does not limit the present invention, and it is only necessary that the driver unit 11 and the driver units 32 are arranged along the virtual plane P. For the sake of simplifying the explanation, while an example will be described here where the driver unit 32 has a substantially cylindrical outer shape with both end surfaces, and its diaphragm 323 has a substantially disc shape, this does not limit the present invention. For example, the outer shape of the driver unit 32 may be a rectangular parallelepiped shape, and the diaphragm 323 may have a dome shape. Furthermore, FIG. 12 is just one example, and a plurality of driver units 32 may be arranged at other positions. In addition, the driver unit 11 may differ from the driver unit 32 in at least one of shape or size, or may have the same shape and size. Even if the driver unit 11 and the driver unit 32 have the same shape and size, number of driver units 11 differs from number of the driver units 32, and thus, the acoustic signal AC1, AC2, AC3, AC4 do not completely cancel out each other in the vicinity of the acoustic signal output device 30, which makes it possible to ensure a constant sound pressure near the user's ears. On the other hand, at a distance from the acoustic signal output device 30, the acoustic signals cancel out each other, so that it is possible to suppress sound leakage of the acoustic signals at a plurality of positions away from the user's ears. Similarly to the first embodiment, preferably, a plurality of driver units 32 (second driver units) is arranged along the virtual circle C that is coaxial with the central axis A of the driver unit 11 (first driver unit). For example, the driver unit 32 may include the virtual circle C, or the driver unit 32 may be located in the vicinity of the virtual circle C. By this means, sound leakage suppression effects over a wide area can be expected.

### Fourth Embodiment

The acoustic signal output device may include a plurality of driver units 21 (first driver units) and a plurality of driver units 32 (second driver units) arranged annularly around the driver units 21. For example, the driver units 11 of the acoustic signal output device 30 illustrated in FIG. 12 may be replaced by the plurality of driver units 21 illustrated in FIG. 11A or FIG. 11B.

### Other Modifications

The present invention is not limited to the above-described embodiments. For example, in the first embodiment to the third embodiment, at least some of the driver units 11, 21 (first driver unit) and the driver units 12, 32 (second driver unit) may be stored in a casing. For example, regions on the D2 side of the driver units 11, 21 and the driver units 12, 32 may be stored in the casing, while regions on the D1 side may be open to outside of this casing. As a result, the acoustic signal AC3 may be emitted from the driver units 11, 21, and the acoustic signal AC4 may be emitted from the driver units 12, 32, into this casing. The acoustic signals AC3, AC4 emitted into the casing may be emitted to outside or do not have to be emitted to outside. For example, this casing may be provided with sound holes such as through-holes, and the acoustic signals AC3, AC4 emitted into the casing may be emitted to outside via the sound holes.

In the above-described embodiments, examples of attaching the acoustic signal output devices 10, 20, 30 to the user's body have been described. However, the acoustic signal output devices 10, 20, 30 do not have to be attached to the user's body. The acoustic signal output devices 10, 20, 30 may be placed near the user's ears without being attached to the user's body. For example, the acoustic signal output devices 10, 20, 30 may be attached to a chair, and the acoustic signal output devices 10, 20, 30 may be positioned near the ears of a user sitting on this chair.

### DESCRIPTION OF REFERENCE NUMERALS

10, 20, 30 acoustic signal output device
11, 12, 21, 32 driver unit

1. An acoustic signal output device, comprising:
one or more first drivers that emit a first acoustic signal in a first direction; and
one or more second drivers that emit a second acoustic signal in the first direction, wherein
a first driver and a second driver are arranged along the same virtual plane,
the second driver is arranged annularly around the first driver, and
in a case where the first acoustic signal is emitted from the first driver and the second acoustic signal is emitted from the second driver, an attenuation rate of the first acoustic signal at a second point relative to a predetermined first point where the first acoustic signal reaches, the second point being farther from the acoustic signal output device than the first point, is designed to be equal to or less than
a predetermined value smaller than an attenuation rate of an acoustic signal at the second point relative to the first point due to air propagation, or
an attenuation amount of the first acoustic signal at the second point relative to the first point is designed to be equal to or greater than
a predetermined value greater than an attenuation amount of the acoustic signal at the second point relative to the first point due to air propagation.

2. The acoustic signal output device according to claim 1, wherein
the first driver emits a third acoustic signal in a second direction that is a direction opposite to or substantially opposite to the first direction,
the second driver emits a fourth acoustic signal in the second direction, and
in a case where the first acoustic signal and the third acoustic signal are emitted from the first driver, and the second acoustic signal and the fourth acoustic signal are emitted from the second driver, an attenuation rate of at least one of the first acoustic signal to the fourth acoustic signal at the second point relative to the first point is designed to be equal to or less than
a predetermined value smaller than the attenuation rate of the acoustic signal at the second point relative to the first point due to air propagation, or
an attenuation amount of at least one of the first acoustic signal to the fourth acoustic signal at the second point relative to the first point is designed to be equal to or greater than
a predetermined value greater than the attenuation amount of the acoustic signal at the second point relative to the first point due to air propagation.

3. The acoustic signal output device according to claim 2, wherein
the second acoustic signal is an antiphase signal of the first acoustic signal or an approximation signal of the antiphase signal of the first acoustic signal,
the third acoustic signal is an antiphase signal of the first acoustic signal or an approximation signal of the antiphase signal of the first acoustic signal, and
the fourth acoustic signal is an antiphase signal of the second acoustic signal or an approximation signal of the antiphase signal of the second acoustic signal.

4. The acoustic signal output device according to claim 1,
wherein the second driver is arranged along a virtual circle coaxial with a central axis of the first driver.

5. The acoustic signal output device according to claim 1,
wherein the second driver is a ring-shaped driver that surrounds the first driver.

6. The acoustic signal output device according to claim 1,
wherein the first driver differs from the second driver in at least one of shape, size, or number.
